(19) United States
(12) Patent Application Publication
(10) Pub. No.: US 2012/0071121 A1
(43) Pub. Date: Mar. 22, 2012

(54) MULTI-CONDUCTOR TRANSMIT ANTENNA FOR MAGNETIC COMMUNICATION SYSTEMS

(75) Inventor: David LeVan, Baldwinsville, NY (US)

(73) Assignee: Lockheed Martin Corporation, Bethesda, MD (US)

(21) Appl. No.: 12/888,143

(22) Filed: Sep. 22, 2010

(51) Int. Cl. H04B 1/04

(52) U.S. Cl. 455/129

(57) ABSTRACT

A magnetic communication system utilizing a multi-conductor transmit antenna is provided. Each of the conductors is supplied with an identical signal such that the magnetic fields generated by each conductor add together to create a like signal having an increased strength. Individual energy barriers are operatively connected to each conductor element in order to limit the current supplied to each conductor to intrinsically safe levels.

### FIELD OF THE INVENTION

The present invention relates to magnetic communication systems, more specifically, to safe communication systems suitable for underground use.

### BACKGROUND

The ability to provide long-distance wireless communication in dangerous and/or obstructed environments, for example in underground mines, is essential for both efficient operation and safety. In some applications, such as coal mining, communications systems are required by regulations for post-accident communications. In these mining operations, transmitting communication signals through earth, water and rock, for example, in addition to the large amounts of steel and concrete used in associated structures, severely impacts the effective range of a communications signal. This is especially true with systems transmitting radio frequency signals through, for example, conventional electric dipole antennas.

Conventional magnetic communications systems that provide low-frequency magnetic signals offer an increased ability to transmit through these materials. However, such systems require a significant supply of current in order to achieve the range necessary for effective use within large mines. Moreover, high current levels conflict with mandatory safety requirements associated with hazardous environments. Typical safety requirements for mining operations include the requirement that all electronic devices, including wireless communication systems, must remain safe despite dangerous atmospheric and environmental conditions, including in the presence of explosive gases and other hazardous and/or toxic materials.

In the case of mining operations, the Mine Safety and Health Administration (MSHA) has mandated the use of “intrinsically safe” (IS) components. “Intrinsically safe” generally means incapable of releasing enough electrical or thermal energy under normal or abnormal conditions to cause ignition of a flammable mixture of methane or natural gas and air of the most easily ignitable composition. These regulations are aimed at reducing the operating risks of electronic devices in these unsafe operating environments.

Electrical equipment used in mines is required to meet these IS standards, which include limitations on the level of current supplied to any single circuit or conductor operation within the mine. This current level limitation severely hinders the operating ranges of communications systems suitable for use in mining operations. More specifically, the strength of a generated communication signal is in part based on the amount of current supplied to, for example, an exposed antenna element.

In addition to these range limitations, reliable communications are difficult to maintain in these extreme environments. More specifically, existing communications systems often comprise single points of failure and are thus easily disabled due to exposure to fire, structural collapses, or power failures.

Accordingly, there remains a need for a reliable communication system having suitable range for underground applications while meeting IS requirements.

### SUMMARY

In one embodiment of the present invention, a magnetic communication system utilizing a multi-conductor transmitting antenna is provided. Each of the conductors is supplied with an identical signal and arranged such that magnetic fields generated by each conductor add together to create a like signal with an increased field strength. The strength of the resulting signal is proportional to the number of conductors used in the antenna. Individual current barriers are operatively connected to each conductor in order to limit the current supplied to each conductor to IS levels.

In another embodiment of the present invention, a multi-conductor antenna element as described above with respect to the first embodiment of the present invention is provided. Each of the conductor elements operates as a separate antenna and is provided with its own power amplifier, antenna matching circuit, and IS current barrier. This arrangement provides for fault-tolerant operation of the communication system, as the failure of an individual component does not affect the operation of the remaining conductor elements.

### BRIEF DESCRIPTION OF THE DRAWINGS

FIG. 1 is a schematic view of a single-conductor magnetic communication system of the prior art.

FIG. 2 is a graph showing the effective underground range of the single-conductor magnetic communication system of FIG. 1. operated at various antenna current levels.

FIG. 3 is a schematic view of a magnetic communication system according to an embodiment of the present invention.

FIG. 4 is a cross-sectional view of an exemplary multi-conductor antenna for use with the system of FIG. 2.

FIG. 5 is a schematic view of a fault-tolerant communications system according to another embodiment of the present invention.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for purposes of clarity, many other elements found in typical communications systems, such as magnetic signal-based wireless communication systems. However, because such elements are well known in the art, and because they do not facilitate a better understanding of the present invention, a discussion of such elements is not provided herein. The disclosure herein is directed to all such variations and modifications known to those skilled in the art.

In the following detailed description, reference is made to the accompanying drawings that show, by way of illustration, specific embodiments in which the invention may be practiced. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout several views.

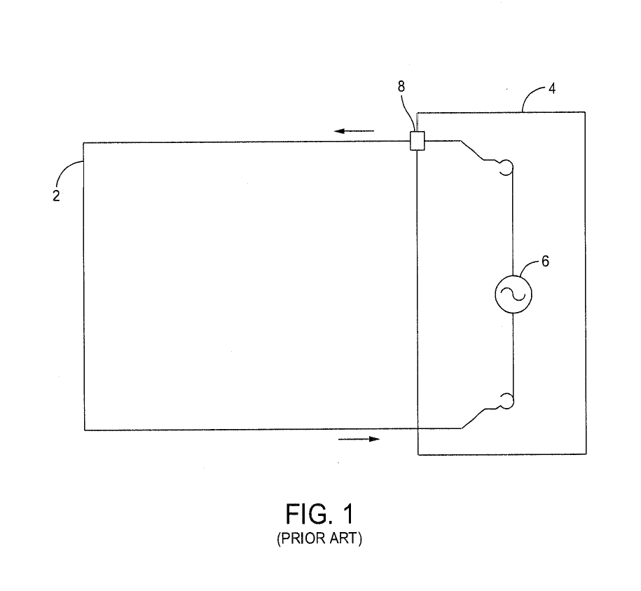

As described above with respect to the background of the present invention, magnetic communication systems possess the ability to transmit signals through earth, rock, and other natural and man-made barriers commonly encountered in underground mining operations. The size of these mines often requires a communication system having a range of several thousand feet, for example, 4,000 ft. to 5,000 ft. Referring generally to FIG. 1, a schematic view of a conventional single-conductor antenna magnetic communications system suitable for use in underground mining operations is shown. The exemplary system comprises an antenna 2 configured to generate a magnetic communications signal. An enclosure 4 may be provided to house the remaining portions of the communication system, such as signal source 6 and antenna tuning circuitry (not shown), and all or part of a current barrier 8 configured to limit the current supplied to the antenna 2 to IS levels. In the exemplary system, antenna 2 comprises a 400 ft. long, single-conductor loop antenna operating at 330 Hz.

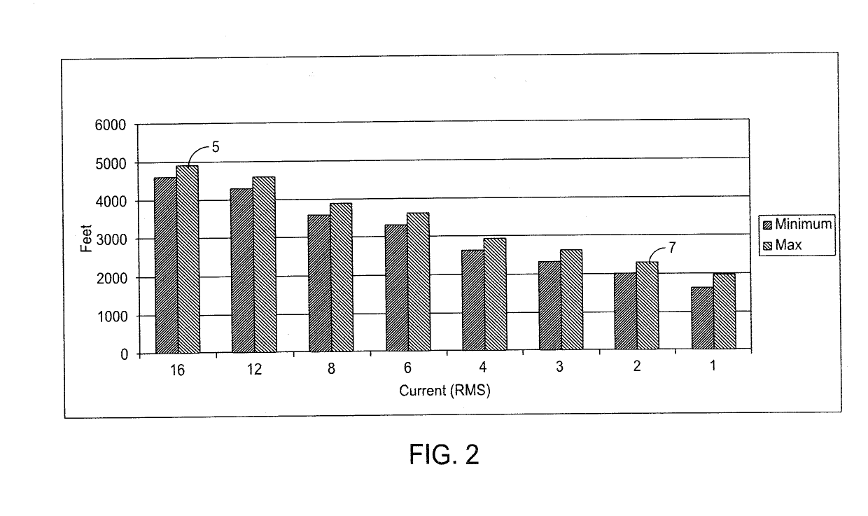

FIG. 2 is a graph showing the effective underground range of the single-conductor magnetic communication system of FIG. 1 operated at various antenna current levels. Operating at full power (approximately 16 amps), a maximum range 5 of almost 5,000 ft. is achieved by the system. However a current of 16 amps through a single antenna conductor greatly exceeds IS requirements. In contrast, operation of the same system at IS levels (about 2.124 amps) results in an approximate 50% reduction in the range of the system, or a maximum effective range 7 of about 2,200 ft. This reduced range renders the exemplary system insufficient for use in large mining operations. It is an object of the present invention to recover this lost range, while retaining the benefits of magnetic communication signals and operating in accordance with IS standards.

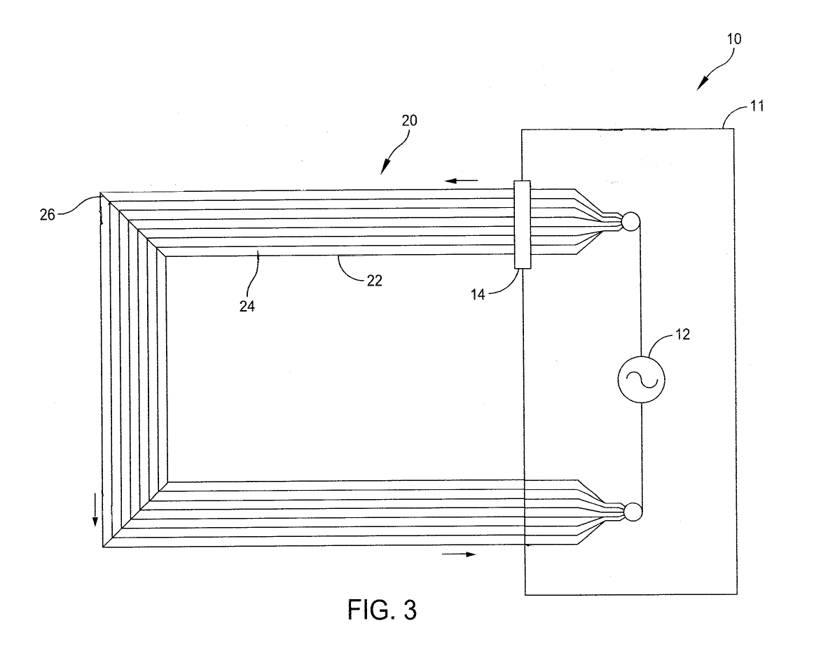

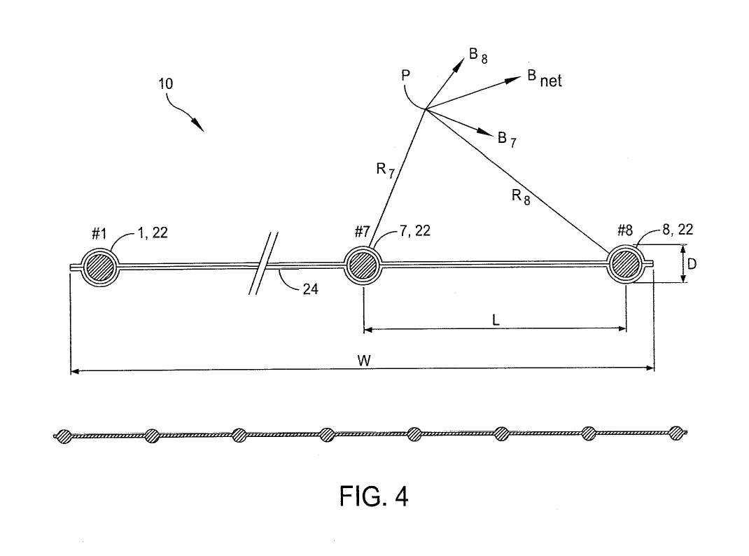

Referring to FIGS. 3-4, a magnetic communication system according to an embodiment of the present invention is shown. The communication system 10 comprises a multi-conductor antenna 20. In the illustrated embodiment, the antenna 20 comprises a loop antenna having a plurality of conductor elements 22, each configured to generate a magnetic communication signal. As will be described below in more detail, these multiple conductors 22 operate together to create a single amplified magnetic signal.

An enclosure 11 may be provided to house the remaining portions of the communication system 10, such as, for example, signal source 12, an audio input, amplifier(s) and antenna tuning circuitry (not shown), and all or part of a current barrier 14. In one embodiment, the enclosure 11 may comprise an explosion-resistant or explosion-proof (XP) enclosure as required by IS requirements. The XP enclosure 11 may be constructed of, for example, metal, and configured to withstand internal explosions of methane-air mixtures without damage to or excessive distortion of its walls, and without ignition of surrounding methane-air mixtures or discharge of flames from inside to outside the enclosure. Specifications for constructing these XP enclosures are provided by the MSHA.

As described above, in order to meet IS safety requirements, each conductor 22 of the antenna 20 is required to be operated at low-energy levels in order to reduce risk of combustion and other hazards when operating in unsafe conditions. To ensure the current supplied to the conductors 22 remains at or below IS levels, at least one current barrier 14 may be provided at the antenna 20 entry and/or exit portions of the XP enclosure 11. The current barrier 14 may comprise, for example, a network of zener diodes and resistors operative to reduce the current supplied to respective conductors 22 to IS levels. In another embodiment, each conductor 22 may be fitted with a separate current barrier 14.

Still referring to FIGS. 3 and 4, the plurality of conductor elements 22 are arranged generally in parallel to form the multi-conductor loop antenna 20. A spacing L is provided between each conductor 22. The spacing may be dictated by IS requirements, for example, no less than one-quarter of an inch, or may be made greater than one-quarter of an inch for packaging purposes, or to aid in achieving desired performance characteristics. In one embodiment, the conductors 22 may be embedded in a backing material 24. The backing material 24 is operative to maintain the desired spacing L between each conductor and to provided physical protection thereto.

The antenna 20 may be manipulated to form folds 26 or bends therein so as to create a loop arrangement. In an alternate embodiment, the folds 26 or bends may be pre-formed in the backing material 24. Accordingly, the backing material 24 may comprise a flexible material, such as a polymer. Moreover, the conductors 22 must have flame resistant insulation or be enclosed in a mandated hose enclosure as approved by the MSHA. Accordingly, in another embodiment, the backing material 24 may be constructed according to these MSHA requirements, so a separate insulation or hose enclosure is not required for each conductor.

While a continuous backing material 24 is shown, it is further envisioned that relatively constant separation of the conductors 22 may be achieved using a plurality of distinct spacing elements (not shown) disposed between the conductors 22 without departing from the scope of the present invention. In this embodiment, the conductors 22 may further comprise the above-mentioned flame-resistant insulation according to IS requirements.

In the illustrated embodiment of FIG. 4, the antenna 20 comprises eight conductors 22 (conductors 1-8) uniformly spaced by the backing material 24. The spacing L should be at least one-quarter of an inch between each conductor 22 according to IS requirements. In an alternate embodiment, the spacing may comprise about one inch for added safety, ideal field combination characteristics, and reduced inductance between the conductors 22.

In an exemplary embodiment, the antenna 20 may be approximately 350 to 400 ft. long for use in a coal mine. The overall width W of the antenna 20 may be 6 to 8 inches, for example, depending on the desired spacing between conductors 22 and the diameter D of each conductor. In an exemplary embodiment, 14 AWG wire is used to form each conductor 22. For installation in a mine, the antenna 20 may be arranged therein either by wrapping it around a coal pillar (preferred) or laid in a tunnel or intersection of two tunnels in a suitable shape to maximize the area enclosed by the wire, for example, the loop arrangement of FIG. 3.

Still referring to FIG. 4, current passing through each conductor 22 of the magnetic loop antenna 20 generates a magnetic field of given strength. These individual fields add together to generate a magnetic field of a larger magnitude then that of the individual fields created by each conductor 22. For example, measuring the magnetic field at a given point P around the antenna 20, the vector B-fields B₇,B₈ generated by current passing through conductors 7 and 8, add together to produce a resulting B field, Bₙₑₜ.

Specifically, the B-field generated by conductor 7 is given by:

B₇=U₀×(N₇I₇A₇)/(4πr₇³)

With U₀ being a permeability factor of approximately 4π×10⁻⁷, N₇ the number of turns of the wire, I₇ the current through conductor 7, A₇ the area of the loop in square meters, and r₇ the distance from the point of measurement to the center of the conductor 7. Similarly, the B-field generated by the conductor 8 is:

B₈=U₀×(N₈I₈A₈)/(4πr₈³)

The sum of these vectors, Bₙₑₜ, is the resulting magnetic field produced from the combination of respective fields generated from each conductor 7,8. During operation of the antenna 20 of the present invention each of the eight conductors generates a B-field, and each of the eight B-fields are summed to form a resulting signaling B-field of increased magnitude.

In embodiments of the communication system of the present invention, the same signal is driven through each conductor 22. In one embodiment, this is accomplished using the single signal source 12 coupled to each conductor 22. Accordingly, the characteristics of the resulting combination signal remains unchanged, but for the accompanying increase in magnitude. As noted above in the illustrated embodiment, eight separate conductors 22 are used to create a magnetic signal field of sufficient strength for underground operation without operating any of the individual conductors having current levels that exceed IS levels.

To illustrate this behavior, an exemplary multi-conductor magnetic communication system has been tested, and the results show below. Specifically, the system was operated at 330 Hz and 3,200 Hz, with various numbers of conductors selectively supplied with only IS current levels. Adding successive conductors had the following effect on the communication range:

| Transmit | | Antenna | Max. % of In- | |
|---|---|---|---|---|
| Center | Number of | Current | Mine Full | Max. Range |
| Frequency (Hz) | Antennas | (amps RMS) | Range | (Feet) |
| 330 | 1 | 2.12 | 46.7% | 2,296 |
| | 2 | 4.25 | 60.0% | 2,952 |
| | 3 | 6.37 | 73.3% | 3,608 |
| | 4 | 8.50 | 79.3% | 3,900 |
| | 5 | 10.62 | NA | NA |
| | 6 | 12.74 | 93.3% | 4,593 |
| | 7 | 14.87 | NA | NA |
| | 8 | 16.99 | 100.0% | 4,921 |
| 3,200 | 1 | 1.77 | 54.4% | 1,960 |
| | 2 | 3.54 | 63.9% | 2,300 |
| | 3 | 5.31 | 75.0% | 2,700 |
| | 4 | 7.08 | NA | NA |
| | 5 | 8.85 | 81.9% | 2,950 |
| | 6 | 10.62 | NA | NA |
| | 7 | 12.39 | 88.9% | 3,200 |
| | 8 | 14.16 | 94.4% | 3,400 |

As shown above, IS levels of current are limited to about 2.124 amps RMS at 330 Hz. Operating a single conductor 22 at this reduced current level results in an approximate reduction of range inside a mine of about 47% compared to the single conductor operating at approximately 16 amps (FIG. 2). Supplying the single conductor with a 2.124 amp signal operating at 3200 Hz resulted in a range reduction of approximately 54%.

The multi-conductor arrangement of the present invention is able to recover this lost range while maintaining IS compliance. Specifically, the above data shows the effect on range as subsequent parallel conductors are added to the antenna, with each conductor operating at IS levels of approximately 2.124 amps. The total signal strength, and therefore range, grows as each antenna conductor is added. Note that with eight conductors operating simultaneously, essentially 100% of the original range is achieved. In this way, the system of the present invention achieves sufficient range in underground use, while maintaining compliance with IS regulations.

While an eight conductor arrangement is shown and demonstrated, it is understood that any number of conductors may be provided according to targeted system performance requirements, the supplied current levels, wire length, and many other factors without departing from the scope of the present invention.

In another embodiment of the present invention, a fault tolerant arrangement may be applied to the above-described multi-conductor magnetic communication system. Fault tolerant systems are critical in mining and other extreme-condition applications as explosions, fire, collapse, and other unexpected conditions often cause damage to antennas and associated communication system hardware.

Particularly, antenna elements, amplifiers, transmitters, and matching circuits are all single points of failure in traditional wireless communication systems. In these typical arrangements, an operator would be forced to change out failed components in order to restore downed communications. In addition to being labor intensive, these operations may be very dangerous in, for example, mining emergencies where there is coal dust and methane gas in the air. In many instances, an operator or emergency technician may not be permitted, or able to access these damaged components, and thus would be unable to repair the system.

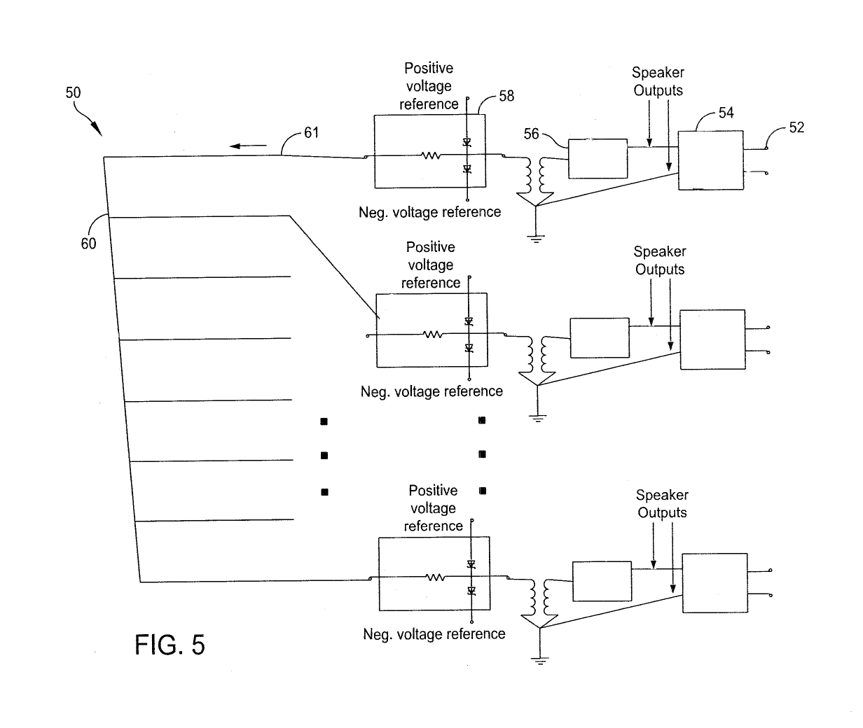

According to an embodiment of the present invention shown in FIG. 5, a communication system 50 is provided having a multi-conductor antenna arrangement, such as that described above with respect to FIGS. 1-4. Specifically, the transmit antenna 60 may be a multi-conductor antenna with two or more wire conductors 61 arranged in parallel with sufficient separation and accompanying current barriers 58 to meet IS requirements.

Fault tolerance is achieved by operating each conductor 61 as a separate antenna with its own power amplifier 54, antenna matching circuit 56, and current barrier 58. Specifically, a common signal supplied by, for example, an audio input 52 is provided to each of the amplifiers 54 of these respective signal paths. The amplified signals are input to respective antenna matching circuits 56, which output to the conductors 61 through individual current barriers 58. As described above, the current barriers 58 may comprise a network of zener diodes and resistors arranged to regulate the current supplied to respective conductors 61. This arrangement may be contained in, for example, the XP enclosure as described above with respect to FIG. 3.

Because each conductor 61 is driven independently and in parallel during normal operation, if one of the signal paths to a given conductor 61 fails, the remaining conductors continue operating uninterrupted, without the need for replacing or repairing equipment. For example, if an antenna conductor 61 is severed, the remaining conductors 61 continue to carry IS levels of current and produce their corresponding magnetic communication signal at the expense of a slight reduction in operating range, rather than a total failure of the system. Likewise, if a power amplifier 54 or an antenna matching circuit 56 fails, the remaining signal paths and antenna conducts continue to operate as normal, and a signal having a reduced strength is still generated as described above with respect to FIG. 4.

A feedback loop may be implemented between the respective amplifier outputs to ensure the delivery of identical signals to each conductor element. The wavelengths of the output signals, however, are relatively large. Accordingly, such feedback arrangements may offer little in the way of performance enhancement of the system.

While the foregoing invention has been described with reference to the above-described embodiment, various modifications and changes can be made without departing from the spirit of the invention. Thus, all such modifications and changes are considered to be within the scope of the appended claims. Accordingly, the specification and the drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations of variations of various embodiments. Combinations of the above embodiments, and other embodiments not specifically described herein, will be apparent to those of skill in the art upon reviewing the above description.

What is claimed is:

1. A magnetic communications system, the system comprising:
at least one signal source for providing a communications signal;
a transmitting antenna comprising a plurality of conductors coupled to said at least one signal source; and
at least one current barrier configured to limit the current supplied from the at least one signal source to the plurality of conductors.

2. The system of claim 1, wherein the plurality of conductors are arranged in parallel and configured to generate respective magnetic communication signals, said magnetic communication signals adding together to create a single communication signal having an increased signaling field.

3. The system of claim 2, wherein each of the conductors are separated from its nearest neighboring conductor by at least one-quarter of an inch, so as to meet intrinsically safe power transmission requirements.

4. The system of claim 1, wherein the at least one current barrier comprises a plurality of current barriers each operatively connected to a corresponding said conductor.

5. The system of claim 1, further comprising at least one amplifier coupled to the signal source.

6. The system of claim 5, wherein the at least one power amplifier comprises a plurality of amplifiers, each amplifier operatively connected to a corresponding conductor element.

7. The system of claim 1, wherein the plurality of conductors of the antenna are embedded in a backing material, the backing material configured to provide uniform separation between each of the plurality of conductors.

8. The system of claim 1, wherein the at least one signal source is an audio input.

9. A fault-tolerant communication system, the system comprising:
a signal source;
a plurality of amplifiers coupled to said signal source;
a plurality of current barriers, each one of said current barriers coupled to a respective output of a corresponding one of said plurality of amplifiers; and
an antenna, said antenna comprising a plurality of conductors, each conductor operatively connected to a respective one of said current barriers and amplifiers.

10. The system of claim 9, wherein the arrangement of each of the plurality of conductors, current barriers, and amplifiers provide an independent signal path with respect to the signal paths created by the remaining conductors, current barriers, and amplifiers such that a failure of one of said other conductors, current barriers, or amplifiers does not affect the operation of the remaining signal paths.

11. The system of claim 9, wherein the plurality of conductor elements are operative to create a plurality of adding magnetic signals.

12. The system of claim 9, wherein the antenna comprises a backing material, the backing material configured to provide uniform spacing between each of said plurality of conductors.

13. The system of claim 12, wherein the plurality of conductors are embedded in the backing material.

14. The system of claim 12, wherein the uniform spacing between each of said plurality of conductors is at least one-quarter of an inch.

15. A method for providing intrinsically safe magnetic communication, the method comprising the steps of:
generating a communications signal;
amplifying said communications signal;
providing said amplified communications signal to an antenna, said antenna comprising a plurality of conductors for generating a plurality of magnetic fields, and
generating a magnetic communications signal by adding each of said plurality of magnetic fields.

16. The method of claim 15, wherein the step of amplifying said communications signal comprises providing a plurality of amplifiers for generating a plurality of amplified communication signals.

17. The method of claim 15, further comprising the step of:
limiting the current of each of said amplified communications signals before providing said antenna with said amplified communications signals.

18. The method of claim 17, wherein the step of limiting the current of each of said amplified communications signals further comprises providing a plurality of current barriers coupled to the outputs of each of said plurality of amplifiers.
